(19) United States
(12) Patent Application Publication
(10) Pub. No.: US 2016/0055204 A1
(43) Pub. Date: Feb. 25, 2016

(54) APPARATUS AND METHOD FOR EXECUTING PARALLEL TIME SERIES DATA ANALYTICS

(71) Applicant: GE Intelligent Platforms, Inc., Charlottesville, VA (US)

(72) Inventors: Sunil MATHUR, East Walpole, MA (US); Michael SOLDA, Norway, MI (US); Ward Linnscott BOWMAN, Mendon, MA (US); Kareem Sherif AGGOUR, Niskayuna, NY (US); Jerry LIN, Seattle, WA (US)

(21) Appl. No.: 14/777,860

(22) PCT Filed: Mar. 18, 2013
(86) PCT No.: PCT/US2013/032810

§ 371 Date: Sep. 17, 2015

(51) Int. Cl. G06F 17/30

(52) U.S. Cl. CPC G06F 17/30445; G06F 17/30551

(57) ABSTRACT

Time series data is identified that is related to a predetermined characteristic and the predetermined characteristic being at least one of an identity of a sensor or a time range. Based upon the identified time series data, the time series data is moved to selected ones of the plurality of separate data storage devices, and the movement is temporary for processing purposes. In parallel, queries are performed on the time series data on each of the selected ones of the plurality of separate data storage devices to obtain a plurality of results. The plurality of results are aggregated.

### CROSS REFERENCES TO RELATED APPLICATIONS

International application no. PCT/US2013/032803 filed Mar. 18, 2013 and published as WO2014149027 A1 on Sep. 25, 2014 and entitled “Apparatus and Method for Optimizing Time Series Data Storage Based Upon Prioritization”;

International application no. PCT/US2013/032802 filed Mar. 18, 2013 and published as WO2014149026 A1 on Sep. 25, 2014 and entitled “Apparatus and method for Memory Storage and Analytic Execution of Time Series Data”;

International application no. PCT/US2013/032823 filed Mar. 18, 2013 and published as WO2014149031 A1 on Sep. 25, 2014 and entitled “Apparatus and Method for Time Series Query Packaging”;

International application no. PCT/US2013/032806 filed Mar. 18, 2013 and published as WO2014149028 A1 on Sep. 25, 2014 and entitled “Apparatus and Method for Optimizing Time Data Storage”;

International application no. PCT/US2013/032801 filed Mar. 18, 2013 and published as WO2014149025 A1 on Sep. 25, 2014 and entitled “Apparatus and Method for Optimizing Time Data Store Usage”;

are being filed on the same date as the present application, the contents of which are incorporated herein by reference in their entireties.

### BACKGROUND OF THE INVENTION

1. Field of the Invention

The subject matter disclosed herein relates the storage and accessing of data and, more specifically the storing and accessing of time series data.

2. Brief Description of the Related Art

Data is stored on data storage devices in a variety of different formats. Additionally, various types of data storage devices are used to store data and these data storage devices may vary in cost. In one example, data may be stored according to certain formats on high cost devices such as random access memories (RAMs). In other examples, data may be stored on low cost devices such as on hard disks.

One type of data that is stored is time series data. In one aspect, time series data is obtained by some type of sensor or measurement device and is stored as a function of time. For example, a measurement sensor may take a reading of a parameter at predetermined time intervals, and each of the measurements is stored in memory. Since large amounts of data are typically involved with time series measurements, the storage of this data becomes particularly cumbersome.

Time series databases such as process historians are commonly used to store time series data for industrial applications (e.g., industrial applications such as gas turbine or other machine-generated applications) as well as other applications. Time series databases also support queries that include analytics such as interpolation and averaging values across a time range.

Previous time series databases available utilized a single server or memory to execute queries. Consequently, the amount of data that a single installation stored was limited, for example, by the disk storage space available on one machine. This architecture also limited the processing capability of a single installation to the processing capability of a single computer. As data volumes and processing requirements have grown, user dissatisfaction with these previous approaches has developed.

### BRIEF DESCRIPTION OF THE INVENTION

Embodiments of the present invention utilize a distributed time series database that stores time series data across a cluster of nodes, for example, utilizing a MapReduce parallel processing framework to execute analytics in a manner that produces results consistent with the existing single-server installations, but at a much larger scale. Embodiments of the present invention enable storing an arbitrarily large time series dataset across an unlimited number of nodes (e.g., the nodes being or including, computers, processors, memories, and/or servers to mention a few examples) in a single system installation.

As described herein, time series queries can be performed in a distributed manner across an entire time series dataset, executing the same analytics and returning the same results as a single-server implementation. Such time series analytics include, but are not limited to, interpolation, sampling, averaging, min/max, median, standard deviation, other aggregation embodiments, moving window averages, counts, and interpolation. Additionally, information is provided indicating data quality and whether the returned data points are real or interpolated. Other examples are possible.

The embodiments described herein provide a way to store and process larger amounts of time series data across a cluster of computers, while still providing the same query and analytic capabilities found in the existing systems.

In many of these embodiments, time series data is grouped related to a predetermined characteristic and the predetermined characteristic being at least one of an identity of a sensor or a time range. Based upon the time series data groupings, the time series data is moved to selected ones of the plurality of separate data storage devices, to temporarily collocate each group of time series data for processing purposes. In parallel, queries are performed on each group of time series data on each of the selected ones of the plurality of separate data storage devices to obtain a plurality of results. The plurality of results are aggregated.

In other aspects, the plurality of results are merged and the results presented together as a single result set. In other examples, the identified time series data is temporarily moved to improve processing performance.

In some aspects, the queries may be an interpolation query, a sampling query, an averaging query, a min/max query, a median determination query, a standard deviation query, an aggregation query, a moving window average query, or a counting query. Other examples are possible.

In some examples, the time series data is a continuous set extending across the plurality of separate data storage devices. In other examples, calculations are performed on at least some of the plurality of results.

In others of these embodiments, an apparatus includes an interface and a processor. The interface has an input and an output.

The processor is coupled to the interface and is configured to identify time series data received at the input that is related to a predetermined characteristic. The predetermined characteristic is at least one of an identity of a sensor or a time range. The processor is further configured to, based upon the identified time series data, issue commands at the output that are effective to move the time series data to selected ones of the plurality of separate data storage devices. The movement is temporary for processing purposes. The processor is further configured to, in parallel, perform queries on the time series data on each of the selected ones of the plurality of separate data storage devices to obtain a plurality of results. The processor is further configured to aggregate the plurality of results.

### BRIEF DESCRIPTION OF THE DRAWINGS

For a more complete understanding of the disclosure, reference should be made to the following detailed description and accompanying drawings wherein:

FIG. 1 comprises a block diagram of a system for performing parallel analytics on time series data according to various embodiments of the present invention;

FIG. 2 comprises a flow chart of an embodiment for providing parallel analytics on time series data according to various embodiments of the present invention; and

FIG. 3 comprises a block diagram of an apparatus for providing parallel time series analytics according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Embodiments of the present invention relate to the development of time-series specific queries that execute within various processing frameworks, for example, the existing MapReduce parallel processing framework. Time series queries can be performed in a distributed manner across an entire time series dataset, executing the same analytics and returning the same results as the single-server implementation. Such time series analytics include, but are not limited to, interpolation, sampling, averaging, min/max, median, standard deviation, and other aggregation embodiments. Other analytics are possible.

Existing time-series analytics that are available in a single-server historian (time series) database can be rebuilt using the MapReduce processing framework (such as within a Hadoop infrastructure), parallelizing the data retrieval and calculations to run on all nodes where relevant time series data is stored. Results are then merged together and presented as a single final result set.

These analytics include, but are not limited to, moving window averages, counts, and interpolation. Additionally, information is provided indicating data quality and whether the returned data points are real or interpolated.

An embodiment of the present invention provides a way to store and process larger amounts of time series data across a cluster of computers, while still providing the same query and analytic capabilities found in the existing systems.

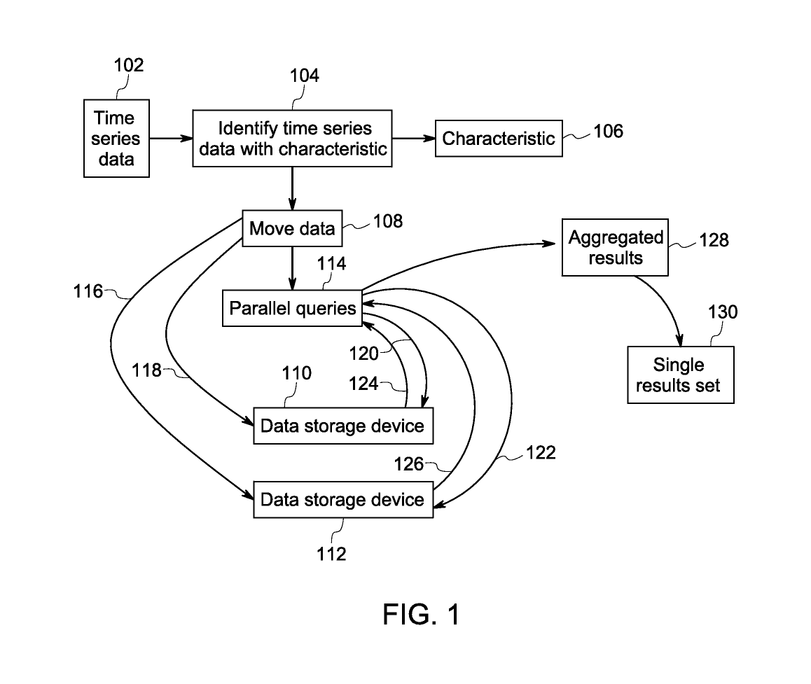

Referring now to FIG. 1, one example of an embodiment for performing or executing parallel queries involving time series data is described. Time series data 102 is received by an identify time series data with characteristic module 104. In one aspect, time series data is obtained by some type of sensor or measurement device and is stored as a function of time. For example, a measurement sensor may take a reading of a parameter at predetermined time intervals, and each of the measurements is stored to disk.

The time series data 102 may be sampled time series data values that extend or are stored over multiple devices. A characteristic 106 may be a sensor identifier or a time range to mention two examples. The identify time series data with characteristic module 104 identifies time series data that is related to the characteristic 106. The characteristic 106 may be a sensor identifier or a time range to mention two examples. The output of the identify time series data with characteristic module 104 is time series data that is identified as matching the characteristic 106 (a sensor A may be a group A and a sensor B may be a group B). In some examples, the output may be the actual data itself. In other examples, the output may be pointers (or other indicators) that specify what the data is and/or where the data is located.

The move data module 108 moves the data groups to one of the first data storage device 110 or the second data storage device 112. In particular, based upon the identified time series data, the move data module 108 moves the time series data to one of the separate data storage devices 110 or 112. The movement of the identified time series data is temporary for processing purposes. In this example, first identified time series data 116 (a subset of time series data 102) is moved to the first data storage device 110. Second identified time series data 118 (another subset of the time series data 102) is moved to the second data storage device 112. Movement of the identified time series data (e.g., data that has been identified as having the characteristic 106) may be accomplished by appropriate computer instructions or commands as known to those skilled in the art.

The first data storage device 110 and the second data storage device 112 may be any type of data storage device that provide temporary storage. In this example, the data storage devices 110 and 112 may be random access memories (RAMs). Other examples of data storage devices are possible.

A parallel queries module 114 performs queries on the time series data stored in the first data storage device 110 and the second data storage device 112. In particular and in parallel, a first query 120 is performed on the first identified time series data in the first data storage device 110 and a second query 122 is performed on the second identified time series data in the second data storage device 112. First results 124 are obtained as a result of the first query 120 and second results 126 are obtained as a result of the second query. An aggregate results module 128 aggregates and merges the two results. The results are presented together as a single result set 130. In other aspects, the identified time series data is moved to minimize future data movement. Further, calculations may also be performed on the results. The results may be presented to a user on any type of graphical presentation device such as on a computer screen or terminal.

In some aspects, the queries 120 and 122 may be an interpolation query, a sampling query, an averaging query, a min/max query, a median determination query, a standard deviation query, an aggregation query, a moving window average query, or a counting query. Other examples of queries are possible.

The identify time series data with characteristic module 104, move data module 108, parallel queries module 114, and aggregate results module 128 may be programmed software instructions that are executed on a processing device or the like such as a microprocessor. Alternatively, the identify time series data with characteristic module 104, move data module 108, parallel queries module 114, and aggregate results module 128 can be implemented as electronic hardware. Still further, combinations of hardware and software may be used.

Consequently, time-series specific queries 120 and 122 can be executed within various processing frameworks such as the MapReduce parallel processing framework, parallelizing the data retrieval and calculations to run on all nodes where relevant time series data is stored. Results are then merged together and presented as a single final result set. Larger amounts of time series data are processed and stored across a cluster of devices (e.g., the data storage devices 110 and 112 may be located at different servers or different computers), while still providing the same query and analytic capabilities found in the existing systems.

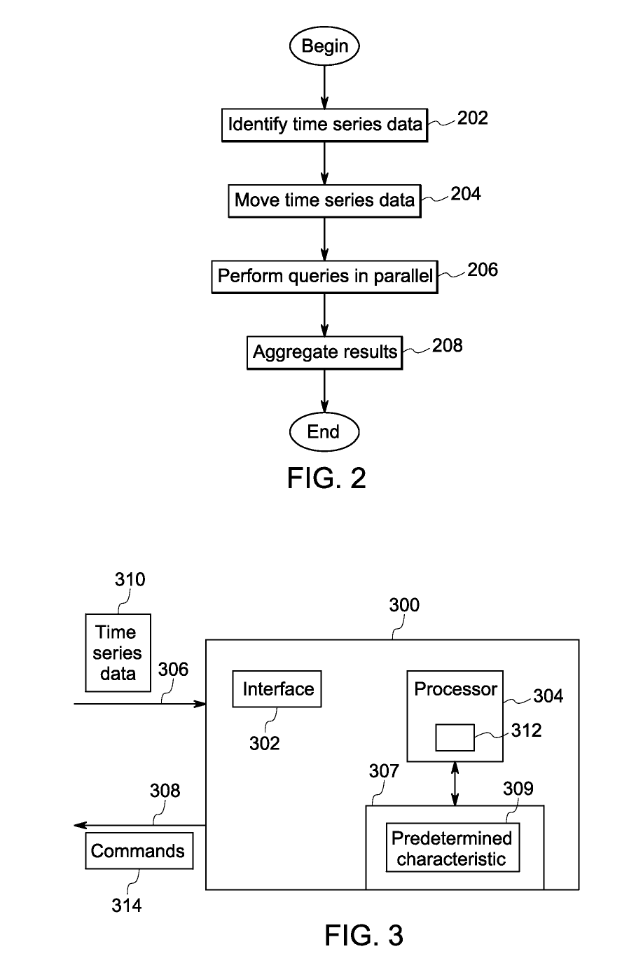

Referring now to FIG. 2, one example of an embodiment for executing queries is described. At step 202, time series data is identified that is related to a predetermined characteristic. The predetermined characteristic is at least one of an identity of a sensor or a time range.

At step 204, based upon the identified time series data, the time series data is moved to selected ones of the plurality of separate data storage devices. The movement is temporary for processing purposes. For example, data from specific sensors and/or from specific time periods may be moved to a particular data storage device. In this way, more efficient operations are performed because data having a very specific characteristic is located together rather than being spread about across multiple physical devices.

At step 206 and in parallel, queries are performed on the time series data on each of the selected ones of the plurality of separate data storage devices to obtain a plurality of results. Since the data with the same or similar characteristics is located together, fewer queries are needed and a more efficient operation results. At step 208, the plurality of results are aggregated. For example, the results may all be pulled together, analyzed, and put in a form so that the aggregate results may be presented to a user. For example, the aggregated results may be presented to a user on a display screen. Furthermore, calculations may be performed on the results and the results of the calculations may also be presented to a user.

Referring now to FIG. 3, an apparatus 300 includes an interface 302 and a processor 304. The interface has an input 306 and an output 308. The apparatus 300 may be disposed at one or more locations such as at a single server or across multiple servers.

The processor 304 is coupled to the interface 302 and is configured to identify time series data 312 (within time series data 310) received at the input 306 that is related to a predetermined characteristic. The predetermined characteristic is at least one of an identity of a sensor or a time range. The processor 304 is further configured to, based upon the identified time series data 312, issue commands 314 at the output 308 that are effective to move the identified time series data 312 to selected ones of the plurality of separate data storage devices. The movement is temporary for processing purposes.

The processor 304 is further configured to, in parallel, perform queries on the time series data 312 on each of the selected ones of the plurality of separate data storage devices to obtain a plurality of results. The processor is further configured to aggregate the plurality of results.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method of executing queries on time series data, the method comprising:
identifying time series data that is related to a predetermined characteristic, the predetermined characteristic being at least one of an identity of a sensor or a time range;
based upon the identified time series data, moving the time series data to selected ones of a plurality of separate data storage devices, the moving being temporary for processing purposes; and
in parallel, performing queries on the time series data on each of the selected ones of the plurality of separate data storage devices to obtain a plurality of results; and
aggregating the plurality of results.

2. The method of claim 1 further comprising merging the plurality of results and presenting the merged plurality of results together as a single result set.

3. The method of claim 1 comprising temporarily moving the identified time series data to improve processing performance.

4. The method of claim 1 wherein the queries are selected from the group consisting of: an interpolation query, a sampling query, an averaging query, a min/max query, a median determination query, a standard deviation query, an aggregation query, a moving window average query, and a counting query.

5. The method of claim 1 wherein the time series data is a continuous set extending across the plurality of separate data storage devices.

6. The method of claim 1 further comprising performing calculations on at least some of the plurality of results.

7. An apparatus configured to execute queries on time series data, the apparatus comprising:
an interface with an input and an output;
a processor coupled to the interface, the processor configured to identify time series data received at the input that is related to a predetermined characteristic, the predetermined characteristic being at least one of an identity of a sensor or a time range, the processor further configured to, based upon the identified time series data, issue commands at the output that are effective to move the time series data to selected ones of a plurality of separate data storage devices, the moving being temporary for processing purposes, the processor further configured to, in parallel, perform queries on the time series data on each of the selected ones of the plurality of separate data storage devices to obtain a plurality of results, the processor further configured to aggregate the plurality of results.

8. The apparatus of claim 7 wherein the processor is further configured to merge the plurality of results and presenting the merged plurality of results together as a single result set.

9. The apparatus of claim 7 wherein the processor is configured to temporarily move the identified time series data to improve processing performance.

10. The apparatus of claim 7 wherein the queries are selected from the group consisting of: an interpolation query, a sampling query, an averaging query, a min/max query, a median determination query, a standard deviation query, an aggregation query, a moving window average query, and a counting query.

11. The apparatus of claim 7 wherein the time series data is a continuous set extending across the plurality of separate data storage devices.

12. The apparatus of claim 7 wherein the processor is configured to perform calculations on at least some of the plurality of results.
